(19) United States
(12) Patent Application Publication
(10) Pub. No.: US 2008/0260185 A1
(43) Pub. Date: Oct. 23, 2008

(54) Method And Apparatus For Automatically Detecting Audio Signal And Sending Control Signal

(76) Inventors: Ching Hung Tseng, Hsinchu (TW); Jen An Wang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/736,587

(22) Filed: Apr. 18, 2007

(51) Int. Cl. H02B 1/00

(52) U.S. Cl. 381/123

(57) ABSTRACT

An apparatus and method for automatically detecting an audio signal and sending a control signal are provided. The present invention is for automatically detecting an audio signal from a conventional IC, and controlling the power amplifier of the driving speaker or the switch of other external circuit. The apparatus at least includes an audio detection circuit and a reset/delay circuit. The audio detection circuit is connected to an audio signal from a conventional IC to detect the presence of the audio signal. The reset/delay circuit, after receiving an output signal from the audio detection circuit, can either reset the reset/delay circuit, or send a control signal after delaying for a period of time. The apparatus of the present invention can also be integrated into the external circuit, such as a power amplifier, to simplify the control to the external circuit by the conventional IC so as to switch off the external circuit to save power when there is no presence of the audio signal.

### FIELD OF THE INVENTION

The present invention generally relates to an apparatus and method for automatically detecting audio signal and sending control signal, applicable to detecting the audio signal from conventional integrated circuitry (IC) and controlling the switch of the amplifier of the driving speaker or other external application circuits.

### BACKGROUND OF THE INVENTION

The speaker relies on the magnetic attraction caused by the electrical signal of the audio source passing through the wires to make the membrane vibrate. Hence, the volume of the sound is proportional to the electrical current. Because the power of the small-voltage signal cannot drive the load of the speaker, the power amplification is required. The sound output of a conventional IC must be able to drive the speaker's circuit, such as power amplifier or other external circuit, to make the sound perfectly audible.

FIG. 1 shows a schematic view of using a bi-polar junction transistor (BJT) as the power amplifier for driving the speaker in a conventional design. As shown in FIG. 1, the audio output of a conventional IC 101 drives a speaker 103 through a BJT 102. The design is simple and low cost as BJT 102 is inexpensive. However, the problems include poor power efficiency and sound quality.

FIG. 2 shows a schematic view of using a power amplifier for driving the speaker in a conventional design. As shown in FIG. 2, the audio output of a conventional IC 101 is connected to a power amplifier 203 through a capacitor 202 to drive a speaker 103. The design improves the sound quality and the power efficiency, but requires additional external passive elements, such as capacitor 202. Also, the power amplifier is more expensive, and still consumes power even when the conventional IC has not audio output.

To solve the power consumption problem during no audio output, the conventional IC includes an additional pin for control signal for switching off power amplifier 203 when conventional IC 101 provides no audio output. Although this approach improves the aforementioned power consumption problem, the conventional IC still requires the software and hardware to send out appropriate control signal for the overall output sound quality, as shown in FIG. 3.

### SUMMARY OF THE INVENTION

The primary object of the present invention is to provide an apparatus and method for automatically detecting audio signal and sending control signal. The present invention can automatically detect the audio signal from a conventional IC, and controls the power amplifier for driving a speaker or other external application circuit without the use of software.

The circuit of the present invention is easy to implement and small in size so as to integrate with the external circuit of a conventional IC, such as power amplifier. This simplifies the control of external circuit by the conventional IC, and switches off the external circuit to save power when there is not audio output from the conventional IC.

The apparatus for automatically detecting audio signal and sending control signal at least includes an audio detection circuit and a reset/delay circuit. The audio detection circuit is connected to the audio signal of the conventional IC for detecting the audio signal from the conventional circuit and outputting a signal. The reset/delay circuit receives the signal from the audio detection circuit and resets the reset/delay circuit or sends a control signal after a delay period expires.

In an embodiment of the present invention, the audio detection circuit includes a detection circuit, which compares the audio signal from the external conventional IC with a bias DC level and outputs a HIGH (5V) or a LOW (0V) signal to the reset/delay circuit.

The reset/delay circuit further includes a resistor R1 and a transistor M1 in series between a power source and a ground. A capacitor C1 is in parallel with transistor M1 with two ends connected to node VC between resistor R1 and transistor M1 and the ground, respectively. Node VC is coupled with two inverters I1, I2 in series, and outputs a control signal to the external circuit switch. Transistor M1 is the reset element, and resistor R1 and capacitor C1 are the delay elements.

According to the embodiment of the present invention, when a conventional IC outputs an audio signal, the audio detection circuit outputs the HIGH signal, and the reset/delay circuit outputs a LOW control signal. Similarly, if the conventional IC does not output an audio signal, the audio detection circuit outputs a LOW signal, and the reset/delay circuit outputs a HIGH control signal.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of using a bi-polar junction transistor (BJT) as the power amplifier for driving the speaker in a conventional design;

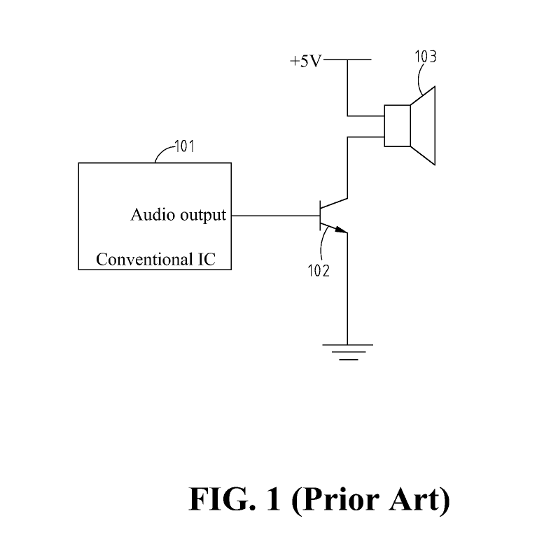

FIG. 2 shows a schematic view of using a power amplifier for driving the speaker in a conventional design;

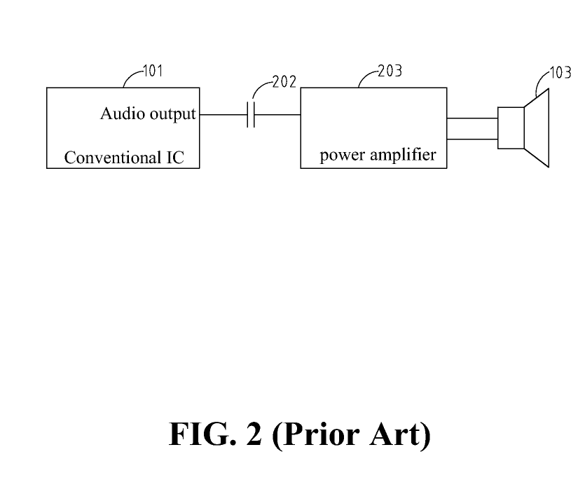

FIG. 3 shows a schematic view of adding a control signal to conventional IC to control the switch of power amplifier;

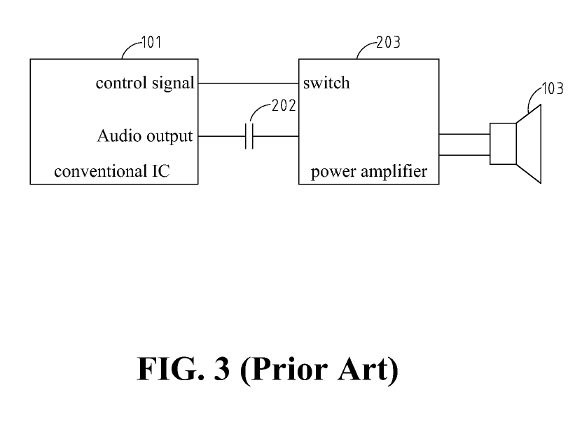

FIG. 4 shows a schematic view of an apparatus for automatically detecting audio signal and sending control signal of the present invention;

FIG. 5 shows a flowchart of the method of detecting the audio signal and sending a control signal of the present invention;

FIG. 6 shows an embodiment of the present invention; and

FIG. 7 shows an actual application of the present invention.

### DETAILED DESCRIPTION OF THE PREFERRED EMBODIMENTS

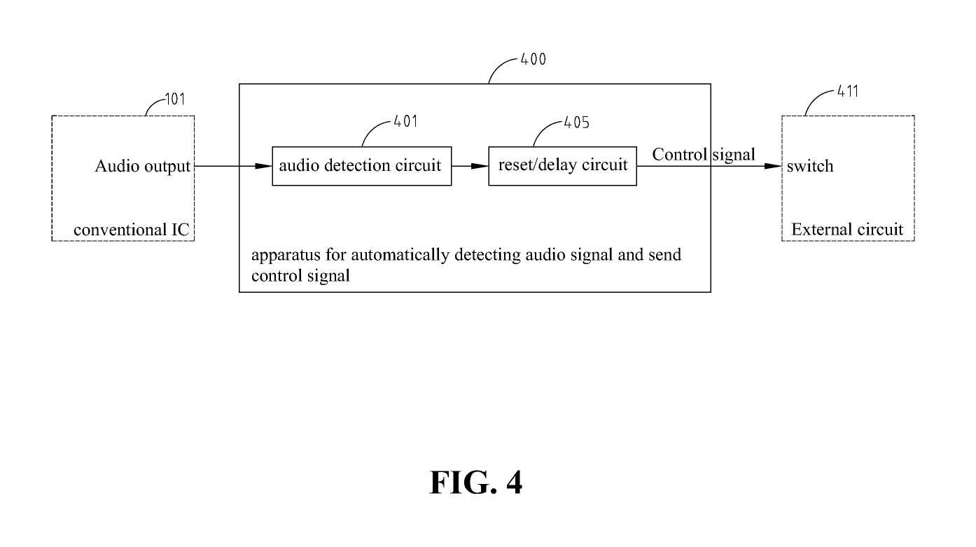

FIG. 4 shows a schematic view of an apparatus for automatically detecting audio signal and sending control signal of the present invention. As shown in FIG. 4, apparatus 400 at least includes an audio detection circuit 401 and a reset/delay circuit 405. Audio detection circuit 401 is connected to receive the audio signal from a conventional IC for detecting whether the conventional IC outputs an audio signal and sending a result signal. Reset/delay circuit 405 receives the result signal from audio detection circuit 401 and resets reset/delay circuit 405 or outputs a control signal.

Reset/delay circuit 405, after receiving the result signal from audio detection circuit 401, delays a period of time before sending the control signal. If audio detection circuit 401 detects an audio signal from conventional IC 101 during the period of delay time, reset/delay circuit 405 will reset the delay, and continue receiving the result signal from audio detection circuit 401. On the other hand, after the period of delay time, if the result signal indicates an audio signal from the conventional IC, reset/delay circuit will send a control signal to external circuit 411. The reason behind the design of having reset/delay circuit 405 to delay before sending the control signal is to prevent the misjudgment because the audio signal may be low frequency.

The control signal from apparatus 400 can work with the switch of the external circuit, for example, the switch of a power amplifier. That is, apparatus 400 can detects that the conventional IC does not output any audio signal and sends a control signal to switch off the amplifier to save power.

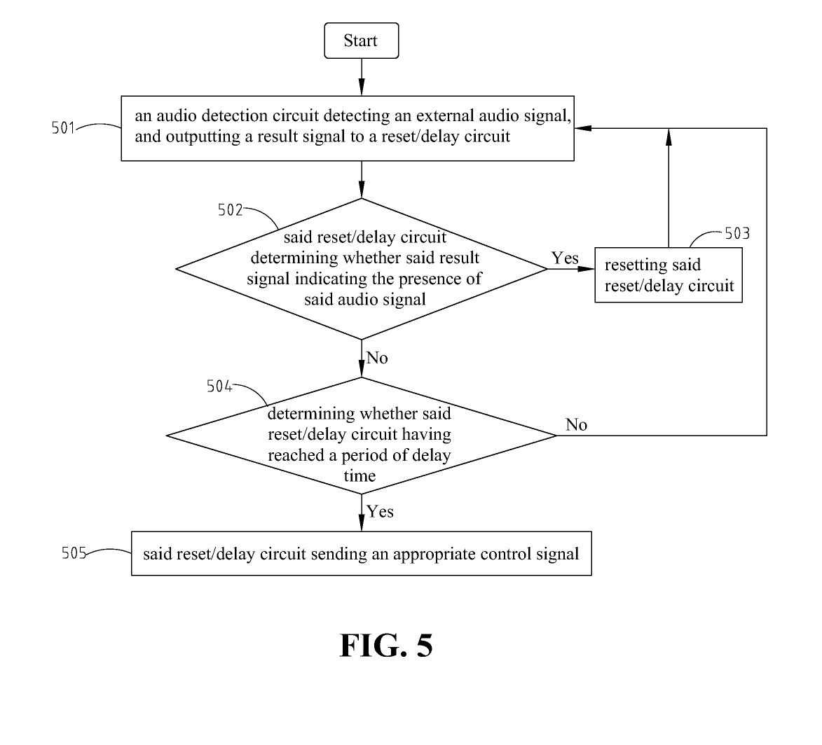

FIG. 5 shows a flowchart of the method of detecting the audio signal and sending a control signal of the present invention. Step 501 is for the audio detection circuit to detect the audio signal of the external circuit and outputs a result signal to the reset/delay circuit. Step 502 is to determine whether the result signal indicates the existence of the audio signal. If so, step 503 is to reset the reset/delay circuit and return to step 501; otherwise, step 504 is to determine whether the reset/delay circuit reaches the period of delay time. If not, return to step 501; otherwise, step 505 is for the reset/delay circuit to send an appropriate control signal. It is worth noting that step 503 is for the reset element of the reset/delay circuit to reset the delay element of the reset/delay element.

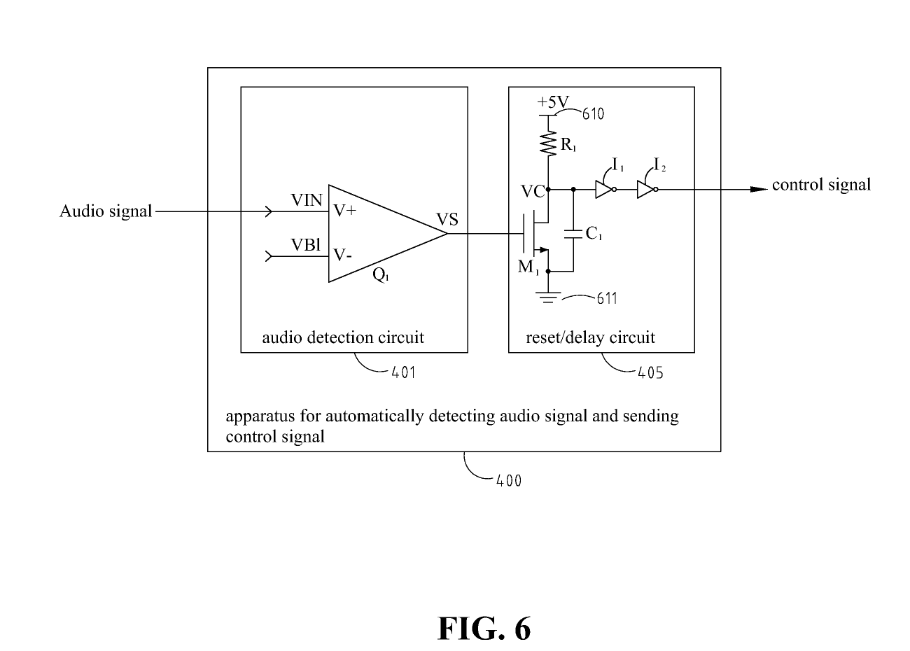

FIG. 6 shows an embodiment of the present invention. As shown in FIG. 6, audio detection circuit 401 includes a detection circuit Q1, such as comparator or a differential amplifier. Input pin VIN of detection circuit Q1 is for receiving audio signal from the external conventional IC, and pin VB1 is a bias DC level. When the DC level of pin VIN is higher than the bias DC level of pin VB1, the voltage level at output pin VS of detection circuit Q1 rises to HIGH (5V). On the other hand, if the DC level of pin VIN is lower than the bias DC level of pin VB1, the voltage level at output pin VS is lowered to LOW (0V). Pin VS, i.e., the result signal, of detection circuit Q1 is coupled with NMOS transistor M1 of reset/delay circuit 405.

Reset/delay circuit 405 further includes a resistor R1 and a transistor M1 in series between a power source 610 and a ground 611. A capacitor C1 is in parallel with transistor M1 with two ends connected to node VC between resistor R1 and transistor M1 and ground 611, respectively. Node VC is coupled with two inverters I1, I2 in series, and outputs a control signal to the external circuit switch. Transistor M1 is the reset element, and resistor R1 and capacitor C1 are the delay elements.

In summary, if the conventional IC outputs an audio signal to pin VIN of audio detection circuit 401, pin VS output a high level signal. Reset/delay circuit 405 receives the high level signal from pin VS, and outputs a low control signal. Similarly, if the conventional IC does not output any audio signal to pin VIN of audio detection circuit 401, pin VS output a low level signal. Reset/delay circuit 405 receives the low level signal from pin VS, and outputs a high control signal

It is worth noting that the apparatus of the present invention can reduce the number of the control signal pins of the conventional IC and does not require a matching software to work with in order to determine the switching on and off the external circuit, such as amplifier.

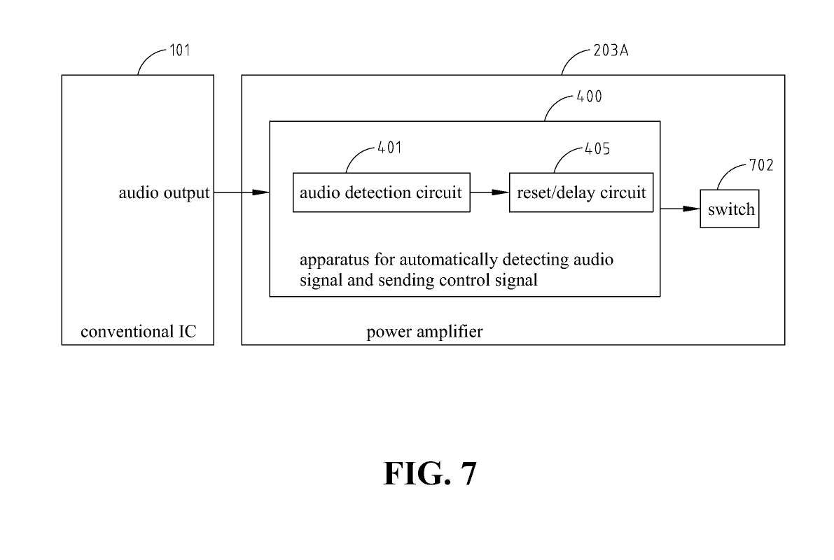

FIG. 7 shows an actual application of the present invention. Without loss of generality, apparatus 400 of the present invention can be realized in an amplifier 203A. As apparatus 400 of the present invention is small in size, apparatus 400 can be integrated into an amplifier 203A. In other words, amplifier 203A with apparatus 400 of the present invention can automatically detect the audio signal and send a control signal to control its own switch 702.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for automatically detecting an audio signal and sending a control signal, comprising:
an audio detection circuit, connected to an audio output of a conventional circuit, detecting whether said conventional IC outputting an audio signal, and then outputting a result signal; and
a reset/delay circuit, for receiving said result signal from said audio detection circuit, and sending a control signal.

2. The apparatus as claimed in claim 1, wherein said reset/delay circuit determines said conventional IC outputting said audio signal, and resets said reset/delay circuit.

3. The apparatus as claimed in claim 1, wherein said reset/delay circuit determines said conventional IC not outputting said audio signal, and sends said control signal after delaying a period of time.

4. The apparatus as claimed in claim 1, wherein said control signal is to control a switch of an external circuit working with said conventional IC.

5. The apparatus as claimed in claim 4, wherein said apparatus is further integrated into said external circuit to form a stand-alone circuit.

6. The apparatus as claimed in claim 4, wherein said external circuit is a power amplifier.

7. The apparatus as claimed in claim 1, wherein said audio detection circuit further comprises a detection circuit, and said detection circuit has a first input pin for receiving said audio signal from said conventional IC, a second input pin connected to a bias DC level, and an output pin for outputting said result signal.

8. The apparatus as claimed in claim 1, wherein said reset/delay circuit further comprises a reset element and a delay element.

9. The apparatus as claimed in claim 8, wherein said reset/delay circuit further comprises a resistor and a transistor in series between a power source and a ground, and a capacitor in parallel with said transistor with two ends connected to node VC between said resistor and said transistor, and said ground, respectively, said node VC being coupled with two inverters in series, and outputting a control signal.

10. The apparatus as claimed in claim 9, wherein said transistor of said reset/delay circuit is said reset element.

11. The apparatus as claimed in claim 9, wherein said resistor and said capacitor of said reset/delay circuit form said delay element.

12. A method for automatically detecting an audio signal and sending a control signal, comprising the steps of:
(a) an audio detection circuit detecting an external audio signal, and outputting a result signal to a reset/delay circuit;
(b) said reset/delay circuit determining whether said result signal indicating the presence of said audio signal;
(c) if said result signal indicating the presence of said audio signal, resetting said reset/delay circuit and returning to said step (a);
(d) if said result signal indicating no presence of said audio signal, determining whether said reset/delay circuit having reached a period of delay time;
(e) if said reset/delay circuit having not yet reached said period of delay time, returning to said step (a); and
(f) if said period of delay time being reached, said reset/delay circuit sending an appropriate control signal.

13. The method as claimed in claim 12, wherein in said step (c), resetting said reset/delay circuit is for a reset element of said reset/delay circuit to reset a delay element.
